(19) United States
(12) Patent Application Publication
(10) Pub. No.: US 2006/0199558 A1
(43) Pub. Date: Sep. 7, 2006

(54) Apparatus and method for detecting preambles according to IEEE 802.11A/B/G wireless LAN standards and its application to a 802.11 multimode receiver

(76) Inventors: Alain Chiodini, Cagnes sur Mer (FR); Frederic Benoist, Villeneuve Loubet (FR)

Correspondence Address: BAKER & DANIELS LLP;111 E. WAYNE STREET, SUITE 800, FORT WAYNE, IN, 46802, US

(21) Appl. No.: 11/347,900

(22) Filed: Feb. 6, 2006

(30) Foreign Application Priority Data
Feb. 12, 2005 (DE) 10 2005 006 443.4

(51) Int. Cl. H04B 17/00; H04B 7/00

(52) U.S. Cl. 455/234.1; 455/226.1

(57) ABSTRACT

The present invention relates to the field of wireless communication systems and in particular to an apparatus and a method for detecting preambles according to IEEE 802.11a/b/g wireless LAN standards and its application to an 802.11 multimode receiver. The proposed apparatus is capable of detecting 802.11a/b/g preambles by using two auxiliary low-resolution ADCs (down to 1 bit) coupled with a preamble detector. The purpose of this apparatus which is located within the RF section of the receiver upstream of the baseband section, is to offload or discharge the baseband functions by performing a signal discrimination and waking up the baseband functions only if the received signal is determined to embed either an 802.11a/g or 802.11b preamble. This results in significant power savings in a multimode 802.11 receiver since the baseband circuitry does not need to be woken up every time a “false” signal is received

### TECHNICAL FIELD OF THE INVENTION

The invention relates to the field of wireless communication systems and in particular to an apparatus and a method for detecting preambles according to IEEE 802.11a/b/g wireless LAN standards and its application to an 802.11 multimode receiver.

### BACKGROUND OF THE INVENTION

Multimode 802.11 wireless LAN receivers must detect and recognize incoming signals when listening to the medium. As 802.11 wireless LAN (WLAN) capabilities become a mainstay technology in a host of consumer electronics products, designers must deal with varying power consumption requirements. Since WLAN devices are most of the time in “idle” mode, the power consumed by a WLAN device as it is just “listening” for WLAN traffic is becoming a critical parameter. Thus, designers must pay special attention to preamble detection techniques when building 802.11a/b/g-enabled architectures.

In 802.11a/b/g-compliant WLAN devices, there are essentially two preambles used; one for the orthogonal frequency division multiplexing (OFDM) mode that was inherited from 802.11a and one for the direct sequence spread spectrum (DSSS) mode that was inherited from 802.11b. The OFDM preamble is described in the frequency domain. It consists of a set of tones with frequencies that are multiples of 1.25 MHz and whose phases are aligned to create a waveform with a small peak to average power ratio. This results in a pattern that repeats every 0.8 microseconds in the time domain.

The DSSS preamble is a series of Barker-11 sequences transmitted with a chip rate of 11 MHz. Each sequence is modulated by the output of a pseudorandom sequence (i.e. transmitted as defined or inverted depending on the output). This is a time domain oriented description. The preamble has a fundamental period of 1 μs.

The WLAN device transmits the preamble that is associated with the data mode that is to follow. The traditional 802.11b data modes (1, 2, 5.5, and 11 Mbit/s) as well as an optional 802.1 μg 22-Mbit/s mode, are all preceded by the DSSS preamble. The 802.11a based data modes (6, 9, 12, 18, 24, 36, 48, and 54 Mbit/s) are all preceded by the OFDM preamble. In order to achieve the highest throughput available, the device that receives the transmission must detect these preambles within 4 μs of the time that they start to arrive. Indication of the preamble detection must be communicated to the medium access control (MAC) to ensure that any planned transmission is delayed until the medium is free. The state of the medium is signaled by a clear channel assessment (CCA) indicator. In this way, the 802.11 protocol minimizes collisions on the air.

The most obvious use of the preamble is to indicate that a WLAN packet is being sent. In fact, the detection of the preamble is a prerequisite to receiving the packet. If a packet is missed, then the performance of the network will suffer. This should steer the algorithm designer to declare a packet detection whenever there is a chance that the preamble is present. However, falsely declaring a packet detection will also cause the network performance to suffer since this will unnecessarily delay any pending transmissions. Still another consequence of falsely declaring packet detection is the likelihood that it will invoke extra signal processing which consumes more power. It will also create the risk of missing a genuine packet during this processing. Since 802.11g WLAN devices operate in the same frequency band as other technologies such as microwave ovens, Bluetooth, or cordless telephones, there are a lot of other signals to avoid. Interfering signals can cause detection algorithms to falsely declare the detection of a WLAN preamble.

The simplest approach to detecting any signal, while expending the minimum amount of signal processing, is to listen for an increase in the ambient energy of the environment. An energy detector can be implemented in the analog or digital domain. Here a threshold is set and the digital processing is triggered when energy is seen above this threshold. This can be a false economy, especially in the potentially noisy environment of an 802.11g WLAN device. If there are a lot of other signals present or if a high sensitivity is desired then the power hungry digital signal processing is invoked too often. To help avoid this, some property of the signal needs to be exploited. If the detection algorithm only had to detect the OFDM preamble then a variety of algorithms could be used. Algorithms that exploit the frequency content of the signal by using a Fast Fourier transform (FFT) or a comb filter can be used very effectively. These architectures are not applicable to the DSSS preamble.

Similarly, the DSSS preamble can be detected robustly by using a simple matched filter architecture. The problem with this architecture is its low speed of reaction. While this was the method of choice for designers of 802.11 and 802.11b WLAN devices, the new requirement for detecting the preamble in 4 μs, or just four DSSS preamble periods, has made this implementation difficult to justify. This architecture is also unsuitable for the OFDM preamble due to its length.

A better method is to use the periodic nature of the preambles. To exploit the periodicity of the preambles, an autocorrelation structure can be used. Since both the DSSS preamble and the OFDM preamble have a well-defined period, it is possible to design a structure that looks for both periods. Comparing received samples in the time domain with those received 0.8 and 1 μs previously will result in a match when either preamble is received. The difference in the periodicity can be used to differentiate between the two preambles. To allow greater confidence in the detection, several preamble periods can be monitored.

### DISCLOSURE OF THE INVENTION

It is object of the invention to provide an apparatus and a method for detecting 802.11a/b/g preambles which are easy to implement in 802.11 wireless receivers, which preform a quick and reliable preamble detection and allow for reducing the power consumption of the associated receiver.

This object is achieved by providing an apparatus and a method for detecting 802.11 preambles as described in the independent claims.

Other features which are considered to be characteristic for the invention are set forth in the dependent claims.

The present invention proposes an apparatus capable of detecting 802.11a/b/g preambles by using two auxiliary low-resolution ADCs (down to 1 bit) coupled with a preamble detector, for example of the autocorrelation type. The purpose of this apparatus which is located within the RF section of the receiver upstream of the baseband section, is to offload or discharge the baseband functions by performing a signal discrimination and waking up the baseband functions only if the received signal is determined to embed either an 802.11a/g or 802.11b preamble. This results in significant power savings in a multimode 802.11 receiver since the baseband circuitry does not need to be woken up every time a “false” signal is received

The apparatus includes a DC offset cancellation system comprising two low-resolution ADCs (1 bit in the example), an RSSI block for in-band power measurement, a preamble detector and an evaluation block (state machine). Low resolution quantized signals feed the preamble detector which is comprised of two sub-units running concurrently. The first sub-unit is devoted to detecting 802.11a preambles while the second sub-unit tackles 802.11b preambles. DC offset free baseband I/Q signals are used for power measurement in the RSSI block.

The offset cancellation block, the power measurement strip and the preamble detector run in parallel using the same clock thus ensuring a rapid preamble detection time which is highly critical for 802.11a/g signals.

The proposed apparatus is able to give a relative signal quality indication. It then becomes possible to compare the SNR associated with two different antennas (antenna diversity).

### BRIEF DESCRIPTION OF THE DRAWINGS

FIG. 1 depicts a block diagram of proposed apparatus.

FIG. 2 depicts a state diagram of the state machine.

### DESCRIPTION OF A PREFERRED EMBODIMENT OF THE INVENTION

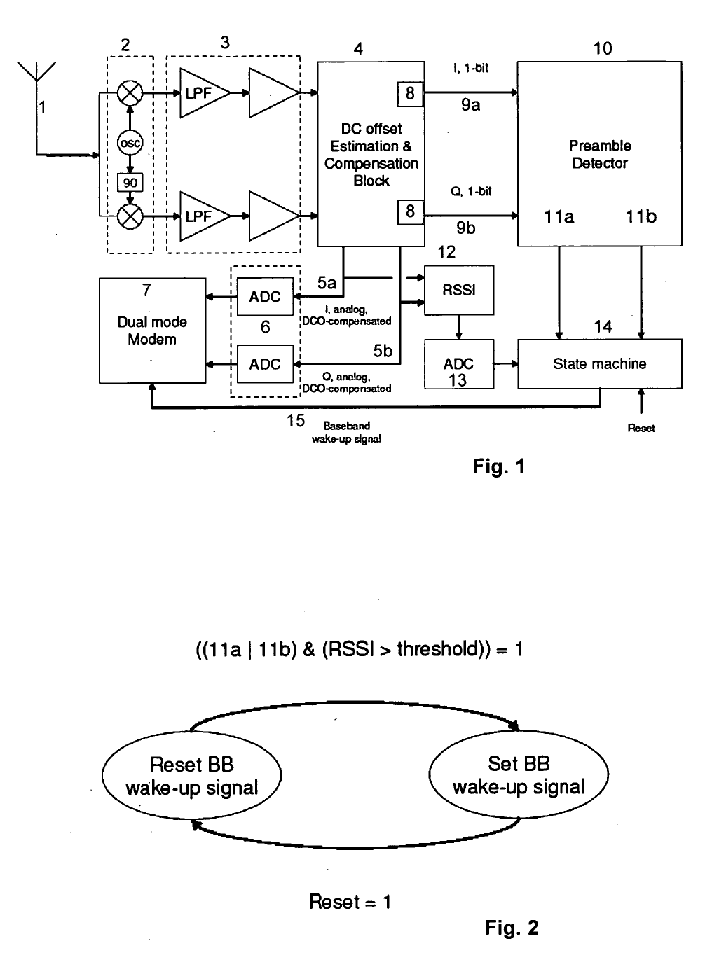

In FIG. 1 a schematic block diagram of an 802.11 receiver is shown comprising the preamble detector according to the present invention. A signal received from an antenna 1 is fed to a mixer block 2 where it is down converted to analog I and Q baseband output signals. The down converted analog I/Q signals output from the mixer block 2 are low pass filtered and amplified in a filter and amplifier block 3 and input to a DC offset estimation and compensation block 4 where the I/Q signals are DC offset compensated. Various DC offset compensation techniques are known in the art which could also be used here. DC offset estimation and compensation block 4 maintains the offset levels and the quantization noise level low enough so as not to disturb the power estimation and preamble detection processes. The DC offset estimation and compensation must be fast enough so as not to introduce damageable delays in the detection.

The DC offset compensated I/Q signals 5a, 5b output from the DC offset estimation and compensation block 4 are input to an analog-to-digital converter block 6 as well as to a RSSI block 12 where the in-band power is measured. In the analog to digital converter block 6 the analog I/Q signals 5a, 5b are converted to digital I/Q signals which are input to the baseband section of the receiver comprising a (dual mode) modem 9 where the digital I/Q signals are demodulated in order to recover the originally transmitted information.

According to the present invention, there are provided two auxiliary low-resolution analog to digital converters 8 arranged between the DC offset estimation and compensation block 4 and a preamble detector 10, or, preferably located within the DC offset estimation and compensation block 4. The low-resolution ADCs 8 preferably consist of 1-bit ADCs. These ADCs 8 are used to take advantage of the particular 802.11a/b/g preamble structure (phase modulation) and convert the DC offset compensated analog I/Q-signals 5a, 5b into digital 1-bit I/Q signals streams 9a, 9b which are input to the preamble detector 10.

The preamble detector 10 which includes at least two detecting subunits working on a 1-bit quantized signal is able to detect any 802.11a/b/g preambles. To accomplish this, the preamble detector may use circuits and methods well known in the art, e.g. based on autocorrelation, or any other circuits and methods which will be developed in the future. If the preamble detector 10 detects an 802.11 preamble it gives an indication on its two outputs 11a or 11b whether the detected preamble is a 802.11a or 802.11b preamble. The two outputs 11a, 11b of the preamble detector are connected to corresponding inputs of an evaluation block including a state machine 14.

Apart from feeding the ADC block 6 serving the baseband section, the analog, DC-offset compensated I/Q signals 5a, 5b are input to the RSSI block 12 where the in-band power of the signals is measured. If the in-band power of the signals exceed a certain threshold, the RSSI block 12 outputs an analog signals which is input to an analog digital converter 13. The ADC 13 outputs a digital signal which indicates whether an in-band signal with considerable power has been received. The output signal of the ADC 13 is input to the state machine 14 in the evaluation block.

FIG. 2 shows the state diagram of the state machine 14 of the evaluation block that is
((11a|11b) & (RSSI>threshold))=1.

Four input lines of the state machine determine which transitions are followed:

The 11a detection line (output from the preamble detector),

The 11b detection line (output from the preamble detector),

The RSSI input (output from the RSSI/ADC),

The reset line.

Once the state machine 14 receives a signal on its RSSI input indicating that an in-band signal with considerable power has been received (i.e. when its measured in-band power exceeds a preset threshold) the outputs 11a, 11b of the preamble detector 10 are sampled. Whenever the preamble detector detects a 802.11a/b preamble it outputs a signal at either the 11a or 11b output to the state machine 14 and the state machine 14 switches in either of its two states and outputs a baseband wake-up signal 15 which then enables the corresponding baseband functions (modem 9) to recover the received 802.11a, 802.11b, or 802.1 μg signals. Given the latencies of the various blocks involved in the proposed apparatus, the baseband layer can be woken up within 2 μs from the beginning of the short preamble.

### LIST OF REFERENCE NUMERALS

1 Antenna
2 Mixer block
3 Filter and amplifier block
4 DC offset estimation & compensation block
5a, 5b DC offset compensated I/Q signals
6 ADC block
7 Modem
8 low-resolution ADCs
9a, 9b 1-bit signal streams
10 Preamble Detector
11a, 11b Outputs of Preamble Detector
12 RSSI block
13 ADC
14 State machine
15 Baseband wake-up signal

1. A 802.11a/b/g preamble detector, embedded in a 802.11 multimode receiver including a radio frequency section and a baseband section, and comprising:
a DC offset estimation and compensation block for performing a DC offset compensation on analog I/Q signals obtained from received and down converted radio signal, and for outputting analog DC offset compensated I/Q signals,
low-resolution analog to digital converters for converting the DC offset compensated analog I/Q signals to n-bit digital I/Q signal streams,
a preamble detector for detecting 802.11a/b/g preambles within the n-bit digital I/Q signal streams and for generating an output signal indicating the type of the detected preamble,
an RSSI block for measuring the in-band power of the analog DC offset compensated I/Q signals and for generating an output signal when the measured in-band power exceeds a preset threshold, and
an evaluation block comprising a state machine for generating a wakeup signal for the baseband section of the receiver when the measured in-band power exceeds a preset threshold and the preamble detector detects a 802.11a/b/g preamble.

2. The 802.11a/b/g preamble detector according to claim 1, characterized in that the low-resolution analog to digital converters are 1-bit ADCs.

3. The 802.11a/b/g preamble detector according to claim 1, characterized in that it is embedded in the radio frequency section of the receiver.

4. The 802.11a/b/g preamble detector according to any claim 1, characterized in that the preamble detector comprises of two sub-units, a first sub-unit for detecting 802.11a preambles and a second sub-unit for detecting 802.11b preambles.

5. A method for detecting preambles according to 802.11a/b/g wireless standard in a 802.11 multimode receiver, comprising the steps of:
receiving and down converting a radio signal in a radio frequency section of the receiver for obtaining analog I/Q signals;
performing a DC offset compensation on the analog I/Q signals in a DC offset estimation and compensation block, for generating analog DC offset compensated I/Q signals;
applying a low-resolution analog to digital conversion to the DC offset compensated analog I/Q signals for generating n-bit digital I/Q signal streams, detecting 802.11a/b/g preambles within the n-bit digital I/Q signal streams in a preamble detector, and generating an output signal indicating the type of the detected preamble,
measuring the in-band power of the analog DC offset compensated I/Q signals in a RSSI block and generating an output signal when the measured in-band power exceeds a preset threshold, and
utilizing an evaluation block comprising a state machine for generating a wakeup signal for the baseband section of the receiver when the measured in-band power exceeds a preset threshold and the preamble detector detects a 802.11a/b/g preamble.

6. The method according to claim 5, characterized in that the steps of performing the DC offset compensation, the in-band power measurement and the preamble detection are performed at the same time in parallel.

7. The method according claim 5, characterized in that the DC offset compensated analog I/Q signals are converted into 1-bit digital I/Q signal streams.

8. The 802.11a/b/g preamble detector according to claim 2, characterized in that it is embedded in the radio frequency section of the receiver

9. The 802.11a/b/g preamble detector according to claim 2, characterized in that the preamble detector comprises of two sub-units, a first sub-unit for detecting 802.11a preambles and a second sub-unit for detecting 802.11b preambles.

10. The 802.11a/b/g preamble detector according to claim 3, characterized in that the preamble detector comprises of two sub-units, a first sub-unit for detecting 802.11a preambles and a second sub-unit for detecting 802.11b preambles.

11. The method according claim 6, characterized in that the DC offset compensated analog I/Q signals are converted into 1-bit digital I/Q signal streams.
